(19) United States
(12) Patent Application Publication
(10) Pub. No.: US 2026/0166943 A1
(43) Pub. Date: Jun. 18, 2026

(54) Heat pump architecture for improving heating performance

(71) Applicant: Hanon Systems, Daejeon (KR)

(72) Inventors: Jongyeong Byun, Rochester Hills, MI (US); Minwoong Kang, Novi, MI (US); Jim Tasiopoulos, West Bloomfield, MI (US); Steven Koester, Sylvania, OH (US); Rodney Callahan, Novi, MI (US)

(21) Appl. No.: 19/384,600

(22) Filed: Nov. 10, 2025

Related U.S. Application Data
(60) Provisional application No. 63/733,849, filed on Dec. 13, 2024.

(51) Int. Cl. B60H 1/00; F25B 40/02

(52) U.S. Cl. CPC B60H 1/00385; B60H 1/00314; B60H 1/00899; F25B 40/02; B60H 2001/00957; F25B 2400/0401; F25B 2400/13; F25B 2400/16; F25B 2600/2509

(57) ABSTRACT

A refrigerant circuit for a thermal management system and a method of operating the same are disclosed. The refrigerant circuit comprises a compressor, a condenser, an economizer, and an evaporator. The compressor has a discharge side, a suction side, and an injection side. A first bypass recirculation discharge fluid line for selectively providing fluid communication between the discharge side and the injection side of the compressor, and a second bypass recirculation discharge fluid line for selectively providing fluid communication between the discharge side and the suction side of the compressor.

### CROSS-REFERENCE TO RELATED APPLICATION

This application claims the benefit of U.S. Provisional Patent Application Ser. No. 63/733,849, filed Dec. 13, 2024, the entirety of which is herein incorporated by reference.

### FIELD

The present disclosure relates to a thermal management system, and more particularly, to a refrigerant circuit of a thermal management system having multiple bypass features.

### BACKGROUND

A thermal management system for use in an electric vehicle may utilize a heat pump system in order to manage the temperature of various components of the electric vehicle and/or to heat or cool the air delivered to the passenger cabin of the vehicle. The heat pump system is circulated by a refrigerant and includes at least a compressor, a first heat exchanger acting as a condenser, an expansion element, and a second heat exchanger acting as an evaporator. The compressor of the system may be operated to increase the temperature of the refrigerant in order to supply heat to the downstream condenser, which is in turn placed in heat exchange relationship with air delivered to the passenger cabin. Accordingly, the heating capacity of the condenser may be influenced by the ambient air temperature. The heating capacity of the condenser is therefore dependent on the temperature and flow rate of the refrigerant entering the condenser following compression within the compressor.

One disadvantage of the heat pump system occurs at low ambient air temperatures, where a high heating load is required in the passenger cabin and the condenser may be unable to provide the necessary heating capacity due to the influence of the ambient air temperature. Accordingly, a device configured to supply additional heat is needed to account for such conditions.

One solution to the problem is adding heat to the air to be delivered to the passenger cabin by incorporating a heating device, such as an electrically powered positive temperature coefficient (PTC) heater or a coolant heater. The introduction of such a heating device increases both the expense and complexity of the thermal management system. In the case of a PTC heater, it is further necessary to adapt the corresponding heating, ventilating, and air conditioning (HVAC) housing to include the heater at a suitable position for adequately heating the air.

In certain instances, a hot gas bypass heating (bypass to evaporator) can be used to eliminate auxiliary heaters. However, the hot gas bypass heating has low efficiency.

Accordingly, it would therefore be desirable to provide a refrigerant circuit for a thermal management system having multiple bypass recirculation discharge fluid lines to improve performance and efficiency.

### SUMMARY

In concordance and agreement with the present disclosure, a refrigerant circuit for a thermal management system having multiple bypass recirculation discharge fluid lines to improve performance and efficiency, has been newly designed.

In one embodiment, a refrigerant circuit, comprises: a compressor having a discharge side, a suction side, and an injection side, wherein the compressor is configured to compress a refrigerant flowing through the refrigerant circuit; and a plurality of bypass recirculation discharge fluid lines selectively providing fluid communication between the discharge side and the injection side of the compressor, and between the discharge side and the suction side of the compressor.

As aspects of some embodiments, each of the bypass recirculation discharge fluid lines is provided with a flow control valve.

As aspects of some embodiments, the flow control valve in each of the bypass recirculation discharge fluid lines is independently and selectively controlled to regulate the flow of the refrigerant through the bypass recirculation discharge fluid lines.

As aspects of some embodiments, the flow control valve in each of the bypass recirculation discharge fluid lines is fully closed to prevent the flow of refrigerant therethrough when in a first operating mode of the refrigerant circuit.

As aspects of some embodiments, the flow control valve in one of the bypass recirculation discharge fluid lines is at least partially open to permit the flow of the refrigerant therethrough while the flow control valve in another one of the bypass recirculation discharge fluid lines is fully closed to prevent the flow of the refrigerant therethrough when in a second operating mode of the refrigerant circuit.

As aspects of some embodiments, the flow control valve in each of the bypass recirculation discharge fluid lines is at least partially open to permit the flow of refrigerant therethrough when in a third operating mode of the refrigerant circuit.

As aspects of some embodiments, the flow control valve in one of the bypass recirculation discharge fluid lines is fully closed to prevent the flow of the refrigerant therethrough while the flow control valve in another one of the bypass recirculation discharge fluid lines is at least partially open to permit the flow of the refrigerant therethrough when in a fourth operating mode of the refrigerant circuit.

In another embodiment, a refrigerant circuit comprises: a compressor having a discharge side, a suction side, and an injection side, wherein the compressor is configured to compress a refrigerant flowing through the refrigerant circuit; a condenser disposed downstream of the compressor; an economizer disposed downstream of the condenser; an expansion element disposed downstream of the economizer; an evaporator disposed downstream of the expansion element and upstream of the compressor; a first bypass recirculation discharge fluid line providing fluid communication between the discharge side and the injection side of the compressor, the first bypass recirculation discharge fluid line having a first flow control valve for selectively controlling a flow of the refrigerant therethrough; and a second bypass recirculation discharge fluid line providing fluid communication between the discharge side and the suction side of the compressor, the second bypass recirculation discharge fluid line having a second flow control valve for selectively controlling a flow of the refrigerant therethrough.

As aspects of some embodiments, the first bypass recirculation discharge fluid line is fluidly connected with a fluid line downstream of the economizer and upstream of the compressor.

As aspects of some embodiments, the second bypass recirculation discharge fluid line is fluidly connected with a fluid line downstream of the evaporator and upstream of the compressor.

As aspects of some embodiments, the second bypass recirculation discharge fluid line is fluidly connected with a fluid line downstream of the expansion element and upstream of the evaporator.

As aspects of some embodiments, the refrigerant circuit further comprises another expansion element disposed downstream of the condenser and upstream of the economizer.

As aspects of some embodiments, the refrigerant circuit further comprises a receiver-drier disposed downstream of the condenser.

As aspects of some embodiments, each of the first and second flow control valves is fully closed to prevent the flow of refrigerant through the first and second bypass recirculation discharge fluid lines when in a heat pump mode of the refrigerant circuit.

As aspects of some embodiments, the first flow control valve is at least partially open to permit the flow of the refrigerant through the first bypass recirculation discharge fluid line while the second flow control valve is fully closed to prevent the flow of the refrigerant through the second bypass recirculation discharge fluid line when in a heat pump with economizer out bypass mode of the refrigerant circuit.

As aspects of some embodiments, each of the first and second flow control valves is at least partially open to permit the flow of refrigerant through the first and second bypass recirculation discharge fluid lines when in a hot gas bypass heating mode of the refrigerant circuit.

As aspects of some embodiments, the first flow control valve is fully closed to prevent the flow of the refrigerant through the first bypass recirculation discharge fluid line while the second flow control valve is at least partially open to permit the flow of the refrigerant through the second bypass recirculation discharge fluid line when in an evaporator bypass heating mode of the refrigerant circuit.

In yet another embodiment, a method of operating a refrigerant circuit comprises the steps of: providing a refrigerant circuit including: a compressor having a discharge side, a suction side, and an injection side, wherein the compressor is configured to compress a refrigerant flowing through the refrigerant circuit; and a plurality of bypass recirculation discharge fluid lines for selectively providing fluid communication between the discharge side and the injection side of the compressor, and between the discharge side and the suction side of the compressor, wherein each of the bypass recirculation discharge fluid lines is provided with a flow control valve; and independently and selectively controlling the flow control valve in each of the bypass recirculation discharge fluid lines to regulate the flow of the refrigerant through the respective bypass recirculation discharge fluid lines.

As aspects of some embodiments, the flow control valve in one of the bypass recirculation discharge fluid lines is fully closed to prevent the flow of the refrigerant therethrough while the flow control valve in another one of the bypass recirculation discharge fluid lines is at least partially open to permit the flow of the refrigerant therethrough in at least one operating mode of the refrigerant circuit.

As aspects of some embodiments, the flow control valve in each of the bypass recirculation discharge fluid lines is either fully closed to prevent the flow of the refrigerant therethrough or at least partially open to permit the flow of the refrigerant therethrough in at least one operating mode of the refrigerant circuit.

### BRIEF DESCRIPTION OF THE DRAWINGS

The above, as well as other objects and advantages of the present disclosure, will become readily apparent to those skilled in the art from reading the following detailed description of an embodiment of the present disclosure when considered in the light of the accompanying drawing which:

FIG. 1 is a schematic flow diagram of a refrigerant circuit of a thermal management system having a first bypass recirculation discharge fluid line and a second bypass recirculation discharge fluid line according to an embodiment of the present disclosure;

FIG. 2 is a schematic flow diagram of a refrigerant circuit of a thermal management system having a first bypass recirculation discharge fluid line and a second bypass recirculation discharge fluid line according to another embodiment of the present disclosure;

FIG. 3 is a graph showing a comparison of a maximum heating capacity (Q) and coefficient of performance (COP) versus an ambient temperature for various operating modes of the refrigerant circuit of FIGS. 1 and 2; and

FIG. 4 is a diagram showing desired operating modes of the refrigerant circuit of FIGS. 1 and 2 in response to required heating capacity and ambient air temperature.

### DETAILED DESCRIPTION

The following description of technology is merely exemplary in nature of the subject matter, manufacture and use of one or more embodiments, and is not intended to limit the scope, application, or uses of any specific embodiment claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

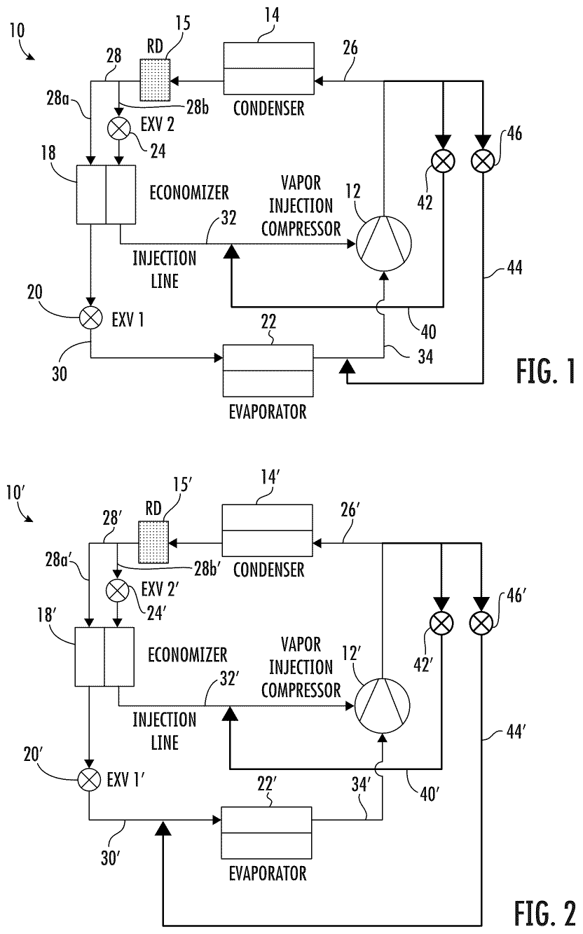

FIG. 1 schematically illustrates an embodiment of a refrigerant circuit 10 according to the present disclosure. The refrigerant circuit 10 may be a closed-loop system that allows heat to be transferred using a refrigerant flowing therethrough. Although the refrigerant circuit 10 described herein is a secondary loop configuration, it is understood that the same principles may be applied to a direct loop configuration, if desired. The refrigerant circuit 10 is shown in substantially simplified schematic form in FIG. 1 and may include additional flow paths, valves, and/or components from those illustrated without necessarily departing from the scope of the present disclosure, so long as the same relationships are present within the refrigerant circuit 10 for prescribing operation thereof in the manner described hereinafter.

The refrigerant circuit 10 may form a portion of a thermal management system. An exemplary thermal management system comprises the refrigerant circuit 10 and/or a coolant circuit (not depicted). The refrigerant circuit 10 may be in heat exchange communication with the coolant circuit. The thermal management system may be incorporated in a vehicle, such as a hybrid or electric vehicle relying upon stored electrical power to provide heating and cooling to various components of the vehicle as well as the air to be delivered to the passenger compartment (also referred to herein as “cabin”) of the vehicle via the operation of the thermal management system including the corresponding refrigerant circuit 10 and/or the coolant circuit. The refrigerant circuit 10 may also be in heat exchange communication or fluid communication with additional components or systems of the associated vehicle in order to heat and/or cool such components or systems. For example, additional heat exchangers may be in fluid communication with the refrigerant of the refrigerant circuit 10, wherein these heat exchangers may be provided as evaporators or chillers for cooling a battery of the vehicle, heat generating electronic components of the vehicle, or the like. Such evaporators or chillers may be in fluid and/or heat exchange communication with one or more secondary refrigerants or coolants associated with such secondary systems. In other circumstances, such heat exchangers may be provided to heat such electronic components from a cold initial state in order for such electronic components to operate most efficiently, or to potentially evaporate or thaw water or ice accumulated on such components. It is understood that the refrigerant circuit 10 may be utilized in any vehicular application without necessarily departing from the scope of the present disclosure.

As provided in FIG. 1, the refrigerant circuit 10 includes a vapor injection compressor 12 having a suction side, a discharge side, and an injection side, a heat exchanger 14 (also referred to herein as “condenser”), a heat exchanger 18 (also referred to herein as “economizer”), an expansion element 20 (e.g., an expansion valve (EXV1)), a heat exchanger 22 (also referred to herein as “evaporator”), and an expansion element 24 (e.g., an expansion valve (EXV2)).

A fluid line 26 fluidly connects the compressor 12 to the condenser 14, fluid lines 28, 28a, 28b fluidly connect the condenser 14 to the economizer 18, a fluid line 30 fluidly connects the economizer 18 to the evaporator 22, a fluid line 32 (i.e., an injection fluid line) fluidly connects the economizer 18 to the injection side of the compressor 12, and a fluid line 34 (i.e., a suction fluid line) fluidly connects the evaporator 22 to the suction side of the compressor 12. As illustrated, a receiver-drier (RD) 15 may be disposed in the fluid line 28 between the condenser 14 and the economizer 18. As illustrated, the expansion element 20 is located downstream of the economizer 18 and upstream of the evaporator 22 in the fluid line 30 and the expansion element 24 is located downstream of the condenser 14 and upstream of the economizer 18 in the fluid line 28b.

The compressor 12 may be any compressor configured to compress the refrigerant of the refrigerant circuit 10 when in a relatively low pressure, gaseous phase to increase the temperature and pressure of the refrigerant when passing through the compressor 12. The saturated vapor from the fluid line 32 is injected into an intermediate port on the injection side of the compressor 12, blending with the refrigerant already undergoing compression. The blended refrigerant accordingly is discharged from the compressor 12 as a relatively high temperature, high pressure gaseous phase.

The condenser 14 is a heat exchanger configured to remove heat from the relatively high temperature, high pressure refrigerant exiting the compressor 12. The relatively high-pressure refrigerant exiting the condenser 14 may be partially liquid and partially gaseous in phase.

In some embodiments, the RD 15 acts as a reservoir for the refrigerant exiting the condenser 14. It may also remove any water vapor from the refrigerant, ensuring that only liquid refrigerant reaches the expansion elements 20, 24, as well as traps undesirable particles and contaminants that could damage other components of the refrigerant circuit 10.

The economizer 18 is a heat exchanger configured to enable a portion of the relatively high-pressure liquid refrigerant from the condenser 14 to exchange heat with another portion of the same refrigerant from the condenser 14, with a reduced pressure and temperature, after passing through the expansion element 24. In some embodiments, the economizer 18 uses the subcooled liquid refrigerant from condenser 14 to generate flash gas, which is then injected into the injection side of the compressor 12 at an intermediate pressure stage.

The expansion elements 20, 24 may refer to any structure or device for contracting and then expanding a flow of the refrigerant therethrough such that a temperature and a pressure of the refrigerant are each lowered following passage therethrough. The expansion elements 20, 24 are accordingly configured to lower a temperature and a pressure of the refrigerant passing therethrough prior to entry into the evaporator 22 and the economizer 18, respectively. It should be appreciated that each of the expansion elements 20, 24 may be a fixed or an adjustable expansion device wherein a flow cross-section through the expansion elements 20, 24 may be varied to alter the drop in pressure and temperature of the refrigerant passing therethrough, as is necessary. For example, the expansion elements 20, 24 may be selectively positionable between a fully open position, a fully closed position, and a plurality of intermediate positions between the fully open and fully closed positions. If utilized, the varying of the flow cross-section through the expansion elements 20, 24 may be active, as desired.

The evaporator 22 is a heat exchanger configured to add heat to the relatively low temperature, low pressure refrigerant prior to entering the suction side of the compressor 12. The refrigerant exiting the evaporator 22 may be gaseous in phase or may be a combination of gaseous and liquid in phase. The evaporator 22 may also be in fluid and heat exchange communication with the coolant circuit, absorbing heat from the coolant originating therefrom. The coolant may be a liquid coolant, such as water, utilized in exchanging heat with at least one heat generating component in direct or indirect heat exchange communication with the coolant of the coolant circuit. For example, the at least one heat generating component may refer to a battery of the vehicle, an electric motor of the vehicle, or to a heat generating electrical component associated with the operation of the vehicle and/or the thermal management system.

In some embodiments, the refrigerant circuit 10 may further include a first bypass recirculation discharge fluid line 40 provided with a flow control valve 42 and a second bypass recirculation discharge fluid line 44 provided with a flow control valve 46. The first bypass recirculation discharge fluid line 40 originates at the discharge side of the compressor 12 and joins into the fluid line 32 between the economizer 18 and the compressor 12 to selectively permit at least a portion of the refrigerant discharged from the discharge side of the compressor 12 to flow into the fluid line 32 prior to entering the injection side of the compressor 12. The second bypass recirculation discharge fluid line 44 originates at the discharge side of the compressor 12 and joins into the fluid line 34 between the evaporator 22 and the suction side of the compressor 12. Each of the flow control valves 42, 46 is independently and selectively positionable between a closed position, an open position, and a plurality of intermediate positions between the closed and open positions (i.e., partially open).

In the closed position, each of the flow control valves 42, 46 prevents the flow of refrigerant through the respective bypass recirculation discharge fluid lines 40, 44. On the contrary, in the open position, each of the flow control valves 42, 46 permits the flow of refrigerant from the discharge side of the compressor 12 through the respective bypass recirculation discharge fluid lines 40, 44. In the intermediate positions, each of the flow control valves 42, 46 permits a portion of the flow of refrigerant from the discharge side of the compressor 12 through the respective bypass recirculation discharge fluid lines 40, 44. As a result, the flow control valves 42, 46 independently and selectively control the flow of the refrigerant from the discharge side of the compressor 12 through the bypass recirculation discharge fluid lines 40, 44, respectively, during various operating modes of the refrigerant circuit 10 as described in greater detail hereinafter.

When in a heat pump mode, both of the flow control valves 42, 46 are maintained in the fully closed position so as to prevent the refrigerant discharged from the compressor 12 from being bypassed into the fluid line 32 and into the fluid line 34. Accordingly, the relatively high temperature, high pressure liquid refrigerant flows from the discharge side of the compressor 12 to the condenser 14 which is in turn placed in heat exchange relationship with air delivered to the passenger cabin. After flowing through the condenser 14, the refrigerant then flows through the RD 15 where any water vapor and undesired particles and contaminants are removed from the refrigerant. A first portion of the refrigerant then flows through the economizer 18 and a second portion of the same refrigerant passes through the expansion element 24, where both its temperature and pressure are reduced, before entering the economizer 18. Inside the economizer 18, the first portion of the high-pressure liquid refrigerant from the RD 15 exchanges heat with the second portion of the same refrigerant having the reduced pressure and temperature to generate flash gas, which is then injected into the injection side of the compressor 12.

After flowing through the economizer 18, the first portion of the high-pressure liquid refrigerant then passes through the expansion element 20, where both its temperature and pressure are reduced, before entering the evaporator 22. Inside the evaporator 22, the refrigerant is in heat exchange relationship with the coolant of the coolant circuit, absorbing heat from it. The refrigerant then flows from the evaporator 22, through the fluid line 34, to the suction side of the compressor 12.

In a heat pump with economizer out bypass mode, the flow control valve 42 of the first bypass recirculation discharge fluid line 40 is at least partially or fully open, while the flow control valve 46 of the second bypass recirculation discharge fluid line 44 remains fully closed. Accordingly, the refrigerant circuit 10 operates as described hereabove for the heat pump mode, with the added feature that a portion of the relatively high temperature, high pressure liquid refrigerant discharged from the discharge side of the compressor 12 combines with the flash gas from the economizer 18 before entering the injection side of the compressor 12.

In a hot gas bypass heating mode (bypass to economizer 18 out and evaporator 22), the flow control valve 42 of the first bypass recirculation discharge fluid line 40 is fully open and the flow control valve 46 of the second bypass recirculation discharge fluid line 44 is at least partially or fully open. According, the refrigerant circuit 10 operates as described hereabove for the heat pump with economizer out bypass mode, with the added feature that another portion of the relatively high temperature, high pressure liquid refrigerant discharged from the discharge side of the compressor 12 combines with the relatively low-pressure vapor refrigerant from the evaporator 22 before entering the suction side of the compressor 12. This hot gas bypass heating mode has a relatively higher capacity and faster warm up time than an evaporator bypass heating mode described hereinafter.

In an evaporator bypass heating mode, the flow control valve 42 of the first bypass recirculation discharge fluid line 40 is fully closed, while the flow control valve 46 of the second bypass recirculation discharge fluid line 44 is at least partially or fully open. Accordingly, the refrigerant circuit 10 operates as described hereabove for the heat pump mode, with the added feature that a portion of the relatively high temperature, high pressure liquid refrigerant discharged from the discharge side of the compressor 12 combines with the relatively low-pressure vapor refrigerant from the evaporator 22 before entering the suction side of the compressor 12.

When in the heat pump mode, the coefficient of performance (COP) is better than the heat pump with economizer out bypass mode, but the heating capacity is less than the heat pump with economizer out bypass mode.

When in the heat pump with economizer out bypass mode, the COP is better than the hot gas bypass heating mode (bypass to economizer out and evaporator) and the heating capacity is affected by the ambient temperature.

When in the hot gas bypass heating mode (bypass to economizer out and evaporator), the heating capacity is relatively unaffected by the ambient temperature, and the COP is less than the heat pump with economizer out bypass mode.

Advantageously, by applying the first and second bypass recirculation discharge fluid lines 40, 44 substantially simultaneously, the heating capacity of the thermal management system can be satisfied without auxiliary heaters. To improve efficiency, the operating modes of the refrigerant circuit 10 can be changed depending on the ambient temperature and the required heat capacity. In certain instances, the first bypass recirculation discharge fluid line 40 increases a flow rate of the refrigerant which passes through the condenser 14 (increasing heating capacity) and the second bypass recirculation discharge fluid line 44 increases heating capacity.

FIG. 2 illustrates a refrigerant circuit 10′ according to another embodiment of the present disclosure. Similar structure of the refrigerant circuit 10′ as to that of the refrigerant circuit 10 described herein and depicted in FIG. 1 is identified with the same reference numeral and includes a single prime symbol (′). Unless otherwise stated, components in this second embodiment function in a manner analogous to their counterparts in the first embodiment.

In this embodiment, the compressor 12′, the condenser 14′, the RD 15′, the economizer 18′, the evaporator 22′, and the bypass recirculation discharge fluid lines 40′, 44′ with respective flow control valves 42′, 46′ of the refrigerant circuit 10′ are arranged substantially similar or the same as the refrigerant circuit 10 described above. Similar to the refrigerant circuit 10, the refrigerant circuit 10′ differs in that the second bypass recirculation discharge fluid line 44′ originates at the discharge side of the compressor 12′ and joins with the fluid line 30′ downstream of the expansion element 20′ and upstream of the evaporator 22′. Thus, the flow control valve 46′ selectively controls the flow of the relatively high temperature, high pressure liquid refrigerant from the discharge side of the compressor 12′ into the fluid line 30′. For simplicity, the operating modes of the refrigerant circuit 10′ are substantially similar or the same as those of the refrigerant circuit 10. However, in this embodiment, the portion of the relatively high temperature, high pressure refrigerant from the discharge side of the compressor 12′ in the second bypass recirculation discharge fluid line 44′ combines with a relatively low temperature, low pressure mixture of liquid and vapor refrigerant after passing through the expansion element 20′, prior to entering the evaporator 22′.

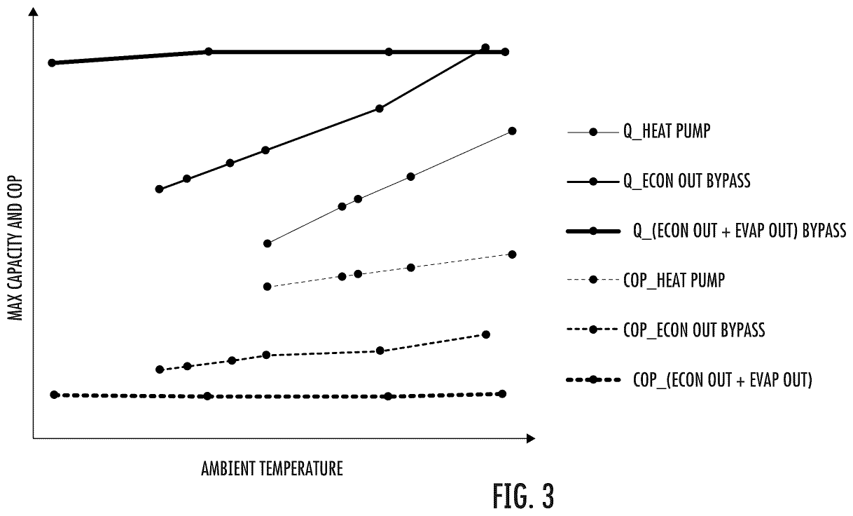

FIG. 3 is a graph showing a comparison of a maximum heating capacity (Q) and coefficient of performance (COP) versus an ambient temperature for various operating modes of the refrigerant circuits 10, 10′ of FIGS. 1 and 2, respectively.

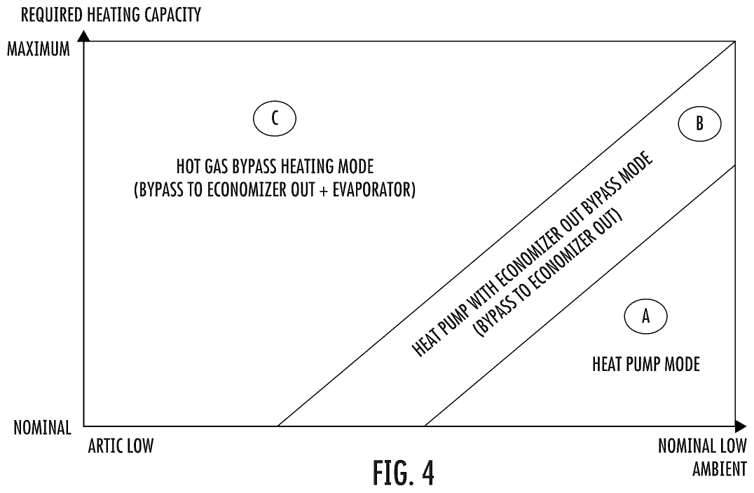

FIG. 4 is a diagram showing a desired operating mode of the refrigerant circuits 10, 10′ of FIGS. 1 and 2, respectively, in response to required heating capacity and ambient air temperature. As illustrated, the heat pump mode is selected when the required heating capacity and the ambient air temperature are within the area designated by circle A, the heat pump with economizer out bypass mode is selected when the required heating capacity and the ambient air temperature are within the area designated by circle B, and the hot gas bypass heating mode is selected when the required heating capacity and the ambient air temperature are within the area designated by circle C. In certain embodiments, the heat pump mode is preferred for its efficiency, the heat pump with economizer out bypass mode offers higher capacity than the heat pump mode, and the hot gas bypass heating mode is utilized when additional heat capacity is required.

From the foregoing description, one ordinarily skilled in the art can easily ascertain the essential characteristics of this present disclosure and, without departing from the spirit and scope thereof, can make various changes and modifications to the present disclosure to adapt it to various usages and conditions.

What is claimed is:

1. A refrigerant circuit, comprising:
a compressor having a discharge side, a suction side, and an injection side, wherein the compressor is configured to compress a refrigerant flowing through the refrigerant circuit; and
a plurality of bypass recirculation discharge fluid lines selectively providing fluid communication between the discharge side and the injection side of the compressor, and between the discharge side and the suction side of the compressor.

2. The refrigerant circuit of claim 1, wherein each of the bypass recirculation discharge fluid lines is provided with a flow control valve.

3. The refrigerant circuit of claim 2, wherein the flow control valve in each of the bypass recirculation discharge fluid lines is independently and selectively controlled to regulate the flow of the refrigerant through the bypass recirculation discharge fluid lines.

4. The refrigerant circuit of claim 2, wherein the flow control valve in each of the bypass recirculation discharge fluid lines is fully closed to prevent the flow of refrigerant therethrough when in a first operating mode of the refrigerant circuit.

5. The refrigerant circuit of claim 4, wherein the flow control valve in one of the bypass recirculation discharge fluid lines is at least partially open to permit the flow of the refrigerant therethrough while the flow control valve in another one of the bypass recirculation discharge fluid lines is fully closed to prevent the flow of the refrigerant therethrough when in a second operating mode of the refrigerant circuit.

6. The refrigerant circuit of claim 5, wherein the flow control valve in each of the bypass recirculation discharge fluid lines is at least partially open to permit the flow of refrigerant therethrough when in a third operating mode of the refrigerant circuit.

7. The refrigerant circuit of claim 6, wherein the flow control valve in one of the bypass recirculation discharge fluid lines is fully closed to prevent the flow of the refrigerant therethrough while the flow control valve in another one of the bypass recirculation discharge fluid lines is at least partially open to permit the flow of the refrigerant therethrough when in a fourth operating mode of the refrigerant circuit.

8. A refrigerant circuit comprising:
a compressor having a discharge side, a suction side, and an injection side, wherein the compressor is configured to compress a refrigerant flowing through the refrigerant circuit;
a condenser disposed downstream of the compressor;
an economizer disposed downstream of the condenser;
an expansion element disposed downstream of the economizer;
an evaporator disposed downstream of the expansion element and upstream of the compressor;
a first bypass recirculation discharge fluid line providing fluid communication between the discharge side and the injection side of the compressor, the first bypass recirculation discharge fluid line having a first flow control valve for selectively controlling a flow of the refrigerant therethrough; and
a second bypass recirculation discharge fluid line providing fluid communication between the discharge side and the suction side of the compressor, the second bypass recirculation discharge fluid line having a second flow control valve for selectively controlling a flow of the refrigerant therethrough.

9. The refrigerant circuit of claim 8, wherein the first bypass recirculation discharge fluid line is fluidly connected with a fluid line downstream of the economizer and upstream of the compressor.

10. The refrigerant circuit of claim 8, wherein the second bypass recirculation discharge fluid line is fluidly connected with a fluid line downstream of the evaporator and upstream of the compressor.

11. The refrigerant circuit of claim 8, wherein the second bypass recirculation discharge fluid line is fluidly connected with a fluid line downstream of the expansion element and upstream of the evaporator.

12. The refrigerant circuit of claim 8, further comprising another expansion element disposed downstream of the condenser and upstream of the economizer.

13. The refrigerant circuit of claim 8, further comprising a receiver-drier disposed downstream of the condenser.

14. The refrigerant circuit of claim 8, wherein each of the first and second flow control valves is fully closed to prevent the flow of refrigerant through the first and second bypass recirculation discharge fluid lines when in a heat pump mode of the refrigerant circuit.

15. The refrigerant circuit of claim 8, wherein the first flow control valve is at least partially open to permit the flow of the refrigerant through the first bypass recirculation discharge fluid line while the second flow control valve is fully closed to prevent the flow of the refrigerant through the second bypass recirculation discharge fluid line when in a heat pump with economizer out bypass mode of the refrigerant circuit.

16. The refrigerant circuit of claim 8, wherein each of the first and second flow control valves is at least partially open to permit the flow of refrigerant through the first and second bypass recirculation discharge fluid lines when in a hot gas bypass heating mode of the refrigerant circuit.

17. The refrigerant circuit of claim 8, wherein the first flow control valve is fully closed to prevent the flow of the refrigerant through the first bypass recirculation discharge fluid line while the second flow control valve is at least partially open to permit the flow of the refrigerant through the second bypass recirculation discharge fluid line when in an evaporator bypass heating mode of the refrigerant circuit.

18. A method of operating a refrigerant circuit comprising the steps of:
providing a refrigerant circuit including:
a compressor having a discharge side, a suction side, and an injection side, wherein the compressor is configured to compress a refrigerant flowing through the refrigerant circuit; and
a plurality of bypass recirculation discharge fluid lines for selectively providing fluid communication between the discharge side and the injection side of the compressor, and between the discharge side and the suction side of the compressor, wherein each of the bypass recirculation discharge fluid lines is provided with a flow control valve; and
independently and selectively controlling the flow control valve in each of the bypass recirculation discharge fluid lines to regulate the flow of the refrigerant through the respective bypass recirculation discharge fluid lines.

19. The method of claim 18, wherein the flow control valve in one of the bypass recirculation discharge fluid lines is fully closed to prevent the flow of the refrigerant therethrough while the flow control valve in another one of the bypass recirculation discharge fluid lines is at least partially open to permit the flow of the refrigerant therethrough in at least one operating mode of the refrigerant circuit.

20. The method of claim 18, wherein the flow control valve in each of the bypass recirculation discharge fluid lines is either fully closed to prevent the flow of the refrigerant therethrough or at least partially open to permit the flow of the refrigerant therethrough in at least one operating mode of the refrigerant circuit.
